(19) United States
(12) Patent Application Publication
(10) Pub. No.: US 2012/0189263 A1
(43) Pub. Date: Jul. 26, 2012

(54) IMAGING APPARATUS AND IMAGING METHOD FOR TAKING MOVING IMAGE

(75) Inventors: Yoshiyuki KATO, Tokyo (JP); Takeharu Takeuchi, Tokyo (JP)

(73) Assignee: CASIO COMPUTER CO., LTD., Tokyo (JP)

(21) Appl. No.: 13/352,607

(22) Filed: Jan. 18, 2012

(30) Foreign Application Priority Data
Jan. 20, 2011 (JP) 2011-009430

(51) Int. Cl. H04N 5/91

(52) U.S. Cl. 386/227; 386/224; 386/E05.003

(57) ABSTRACT

An imaging apparatus including: an imaging section that sequentially takes images of an object; a moving image recording section that sequentially records the images of the object as a series of moving image data; an adjuster that adjusts an imaging condition for imaging the object in accordance with a change in state of the object during imaging and recording of the series of moving image data; a switching section that switches between a first recording frame rate and a second recording frame rate that is higher than the first recording frame rate; and an adjustment controller that controls adjustment of the imaging condition made by the adjuster during the recording of the moving image data at the second recording frame rate, when the switching section switches from the first recording frame rate to the second recording frame rate.

### BACKGROUND OF THE INVENTION

1. Field of the Invention

The present invention relates to an imaging apparatus and an imaging method for controlling a frame rate for taking moving images.

2. Description of Related Art

An imaging apparatus is known, which can switch the imaging frame rate during moving image shooting so that moving image data can be partially reproduced in slow motion or high-speed motion (for example, see Japanese Patent Application Laid-Open Publication No. 2005-136754).

During moving image shooting, imaging conditions are typically adjusted to follow a change in state of an object so as to maintain exposure or white balance suitable for the state of the object at any time. Thus, even when the imaging frame rate is intentionally increased to check a fast-moving main object through slow-motion reproduction, for example, the imaging conditions such as exposure or white balance are adjusted to follow the state of the object. As a result, the brightness or a color tone of the main object cannot be appropriately checked, although the detailed movement of the main object can be checked in slow motion during reproduction of such moving image data.

Therefore, there has been demand for an imaging apparatus and an imaging method that can provide moving image data enabling a user to check a state of a main object appropriately.

### SUMMARY OF THE INVENTION

According to an aspect of the present invention, there is provided an imaging apparatus including: an imaging section that sequentially takes images of an object; a moving image recording section that sequentially records the images of the object as a series of moving image data; an adjuster that adjusts an imaging condition for imaging the object in accordance with a change in state of the object taken by the imaging section during imaging and recording of the series of moving image data; a switching section that switches a recording frame rate for recording a moving image between a plurality of recording frame rates during the imaging and the recording of the series of moving image data, wherein the plurality of recording frame rates include a first recording frame rate and a second recording frame rate that is higher than the first recording frame rate; and an adjustment controller that controls adjustment of the imaging condition made by the adjuster during the recording of the moving image data at the second recording frame rate, when the switching section switches from the first recording frame rate to the second recording frame rate.

According to another aspect of the present invention, there is provided an imaging method using an imaging apparatus that includes an imaging section, the method including: sequentially recording images of an object sequentially taken by the imaging section as a series of moving image data; adjusting an imaging condition for imaging the object in accordance with a change in state of the object taken by the imaging section during imaging and recording of the series of moving image data; switching a recording frame rate for recording a moving image between a plurality of recording frame rates during the imaging and the recording of the series of moving image data, wherein the plurality of recording frame rates include a first recording frame rate and a second recording frame rate that is higher than the first recording frame rate; and controlling adjustment of the imaging condition during the recording of the moving image data at the second recording frame rate, when a recording frame rate is switched from the first recording frame rate to the second recording frame rate.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating a schematic configuration of an imaging apparatus according to a first embodiment of the invention;

FIG. 2 is a flowchart illustrating an exemplary operation according to an imaging process performed by the imaging apparatus shown in FIG. 1;

FIG. 3 illustrates the imaging process shown in FIG. 2;

FIG. 4 is a block diagram illustrating a schematic configuration of an imaging apparatus according to a second embodiment of the invention;

FIG. 5 is a flowchart illustrating an exemplary operation according to an imaging process performed by the imaging apparatus shown in FIG. 4;

FIG. 6 illustrates the imaging process shown in FIG. 5;

FIG. 7 is a block diagram illustrating a schematic configuration of an imaging apparatus according to a third embodiment of the invention;

FIG. 8 is a flowchart illustrating an exemplary operation according to an imaging process performed by the imaging apparatus shown in FIG. 7; and

FIG. 9 illustrates the imaging process shown in FIG. 8.

### DESCRIPTION OF THE PREFERRED EMBODIMENTS

Embodiments of the present invention will be specifically described below with reference to the attached drawings. It is obvious that the embodiments should not limit the scope of the invention.

### First Embodiment

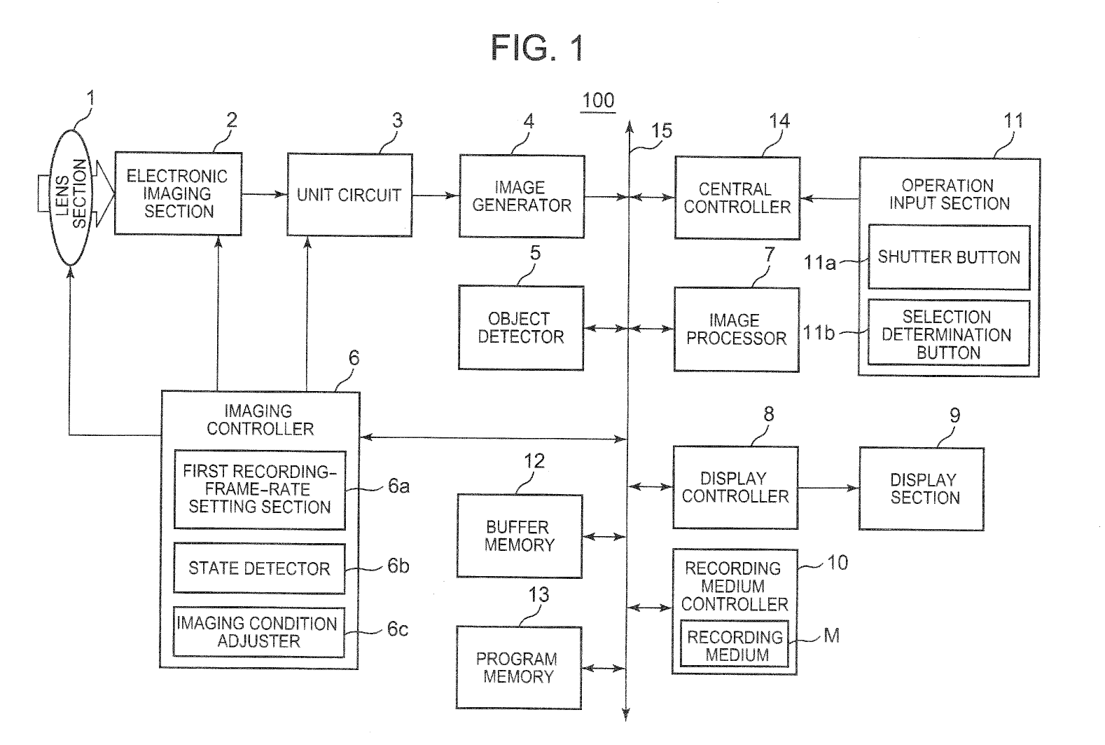

FIG. 1 is a block diagram illustrating a schematic configuration of an imaging apparatus 100 according to a first embodiment of the present invention.

The imaging apparatus 100 according to the first embodiment adjusts imaging conditions of an object in response to a change in state of the object during recording of a moving image of the object as a series of moving image data. When a frame rate for recording a moving image is switched from a first recording frame rate to a second recording frame rate higher than the first recording frame rate during recording of the moving image data, the apparatus 100 controls the adjustment of the imaging conditions during the recording of the data at the second recording frame rate.

Specifically, as shown in FIG. 1, the imaging apparatus 100 includes a lens section 1, an electronic imaging section 2, a unit circuit 3, an image generator 4, an object detector 5, an imaging controller 6, an image processor 7, a display controller 8, a display section 9, a recording medium controller 10, an operation input section 11, a buffer memory 12, a program memory 13, and a central controller 14.

The image generator 4, the object detector 5, the imaging controller 6, the image processor 7, the display controller 8, the recording medium controller 10, the buffer memory 12, the program memory 13, and the central controller 14 are connected to one another through a bus line 15.

The lens section 1 includes, for example, a zoom lens, a focus lens, and an aperture diaphragm, which are not shown, and forms an optical image of an object through these lenses.

The electronic imaging section 2 is disposed on an optical axis of the lens section 1. The electronic imaging section 2 is composed of an image sensor such as a charge coupled device (CCD) or a complementary metal-oxide semiconductor (CMOS). The electronic imaging section 2 converts the optical image passing through the lenses of the lens section 1 to two-dimensional image signals (RGB image data) at a predetermined period corresponding to an imaging frame rate, and outputs the signals to the unit circuit 3.

The unit circuit 3 includes, for example, a correlated double sampling (CDS) circuit, an auto gain control (AGC) amplifier, and an analog-to-digital converter (ADC), which are not shown. The unit circuit 3 holds analog image signals corresponding to an optical image of an object input from the electronic imaging section 2 in the CDS circuit at a predetermined period corresponding to a recording frame rate, amplifies the image signals in the AGC amplifier, and converts the amplified image signals to digital image signals in the ADC. The unit circuit 3 then transmits the digital image signals to the image generator 4.

In this way, the lens section 1, the electronic imaging section 2, and the unit circuit 3 perform imaging of the object.

The image generator 4 generates digital luminance signals Y and digital color-difference signals Cb and Cr (YUV data) from the digital image signals transmitted from the unit circuit 3.

Specifically, the image generator 4 performs a color process including a pixel interpolation process and a γ-correction process to digital image data of each frame image f transmitted from the unit circuit 3 at a predetermined period in its color process circuit (not shown), and then generates the digital luminance signals Y and the digital color-difference signals Cb and Cr (YUV data).

The frame rates, at which the imaging apparatus 100 takes a moving image or records the image as the moving image data, include an imaging frame rate at which the electronic imaging section 2 takes a moving image, an adjustment frame rate at which an imaging condition adjuster 6c adjusts imaging conditions, and a recording frame rate at which the image generator 4 generates each frame image f and records the image in a recording medium M as the moving image data. In the first embodiment, the imaging frame rate is fixed to a high frame rate such as 120 fps or 240 fps, and the adjustment frame rate or the recording frame rate is changed by appropriately reducing frames from such high-rate frames for adjustment or recording.

Such an operation prevents a frame lag when the adjustment frame rate or the recording frame rate is switched, and thereby, the frame rate can be easily and readily changed. Alternatively, the imaging frame rate itself may be changed so as to change the adjustment frame rate or the recording frame rate without reducing the frames, instead of fixing the imaging frame rate and changing the adjustment frame rate or recording frame rate.

The recording frame rates include a frame rate corresponding to a normal moving image shooting, and a frame rate corresponding to high-speed moving image shooting at a speed higher than the normal moving image shooting. For example, the normal recording frame rate is 30 or 60 fps, while the high recording frame rate is 120 or 240 fps. These frame rates however are exemplary only and not limitative, and can be modified or altered as required.

The image generator 4 then outputs the generated image data of the luminance/color-difference signals to the object detector 5, the imaging controller 6, and the image processor 7.

The object detector 5 detects a particular object from the image data of the luminance/color-difference signals of each frame image f output from the image generator 4.

Specifically, the object detector 5 acquires the image data (YUV data) of each frame image f, and performs various types of image processes such as a face detection process, an edge detection process, and a feature extraction process to the image data to detect an area including the particular object (for example, a face area). Specifically, the object detector 5 extracts candidate areas being candidates of the particular object through the face detection process, the edge detection process, and the feature extraction process, for example, and detects an area satisfying predetermined identification conditions as the particular object among the extracted candidate areas.

The predetermined identification conditions include conditions using various references such as shape of, for example, “human face” or “animal”, size including a size ratio of an object to an image over the entire view angle (for example, equal to or larger than a half), and color tone including value of color, saturation, clearness (showiness), or flesh tint.

The face detection process, the edge detection process, and the feature extraction process are known techniques, and detailed description of them is omitted.

In this way, the object detector 5 detects the particular object in the moving image taken by the lens section 1, the electronic imaging section 2, and the unit circuit 3.

The imaging controller 6 controls operations of the lens section 1, the electronic imaging section 2, and the unit circuit 3.

Specifically, the imaging controller 6 includes, for example, a drive source such as a motor and a driver for driving the drive source, both of which are not shown, to move the zoom lens or the focus lens of the lens section 1 in the direction of the optical axis. In addition, the imaging controller 6 includes, for example, a diaphragm drive section (not shown) to expand or reduce the aperture of the diaphragm of the lens section 1 according to an exposure adjustment condition determined by an imaging condition adjuster 6c (described later).

The imaging controller 6 includes, for example, a timing generator (TG) and a driver for driving the electronic imaging section 2, both of which are not shown, to control the operation timing of the electronic imaging section 2 through the TG and the driver in accordance with imaging conditions (for example, exposure time) determined by an imaging condition adjuster 6c. In addition, the imaging controller 6 controls the operation timing of the unit circuit 3 in accordance with the recording frame rate.

Specifically, the imaging controller 6 drives the electronic imaging section 2 at a predetermined timing in accordance with the imaging frame rate or imaging conditions (for example, exposure time) to convert an optical image of the object to analog image signals, and drives the unit circuit 3 at a predetermined timing in accordance with a predetermined recording frame rate (for example, a first normal recording frame rate) to convert the analog image signal corresponding to the optical image of the object input from the electronic imaging section 2 to digital image signals (frame image f). That is, the imaging controller 6 controls the electronic imaging section 2 and the unit circuit 3 to take the moving image of the object composed of a plurality of frame images f, . . . at a period corresponding to the first recording frame rate.

Here, when an instruction to switch the recording frame rate is input by a user with the operation input section 11, the imaging controller 6 converts the analog image signals corresponding to the optical image of the object input from the electronic imaging section 2 to the digital image signal (frame image f) in the unit circuit 3 at a predetermined period corresponding to a recording frame rate (for example, the second high recording frame rate) switched by a first recording-frame-rate setting section 6a (described later).

The imaging controller 6 includes the first recording-frame-rate setting section 6a, a state detector 6b, and the imaging condition adjuster 6c.

The first recording-frame-rate setting section 6a determines the recording frame rate.

Specifically, the first recording-frame-rate setting section 6a determines the recording frame rate according to a drive period of the unit circuit 3 on the basis of a user operation input with the operation input section 11. Specifically, a setting signal of the recording frame rate is output to the central controller 14, which recording frame rate is identified between the recording frame rate corresponding to the normal moving image shooting (hereinafter referred to as a normal recording frame rate) and the recording frame rate corresponding to the high-speed moving image shooting (hereinafter referred to as a high recording frame rate) on the basis of the predetermined user operation of a selection determination button 11b of the operation input section 11. The central controller 14 outputs the setting signal input from the operation input section 11 to the imaging controller 6, and the first recording-frame-rate setting section 6a of the imaging controller 6 sets a recording frame rate corresponding to the input setting signal. That is, in response to the predetermined user operation of the selection determination button 11b during recording of a series of moving image data, the first recording-frame-rate setting section 6a switches between the normal recording frame rate and the high recording frame rate to set the recording frame rate.

In this way, the first recording-frame-rate setting section 6a switches the frame rate for recording a moving image of an object during the recording of the moving image data of the object.

The state detector 6b detects a state of the object on the basis of a plurality of frame images f, . . . constituting a moving image generated through imaging of the object. Specifically, the state detector 6b detects brightness or a color tone of each frame image f on the basis of image data (YUV data) of the luminance/color-difference signals of each frame image f output from the image generator 4.

For example, in the case of detection of brightness of a frame image f, the state detector 6b detects the brightness of the frame image f on the basis of a luminance signal (Y) of each frame image f depending on a predetermined metering (for example, center-weighted metering, spot metering, average metering, and multi-zone metering). For example, in the case of detection of a color tone of a frame image f, the state detector 6b converts the YUV data of each frame image f to image data in a HSV color space, and then calculates a gray pixel estimation condition corresponding to a color temperature of a light source (for example, sunlight, a fluorescent light, a clear sky, and a cloudy sky) from histograms of saturation S and value of color V. The state detector 6b then estimates a gray component contained in each frame image f on the basis of the gray pixel estimation condition.

Here, the state detector 6b may detect brightness or a color tone of each frame image f with reference to a particular object (for example, a human face area) detected by the object detector 5 in each frame image f.

The center-weighted metering is photometry that meters light with an emphasis on the center of the frame image f, the spot metering is photometry that meters light limitedly on a predetermined area of the frame image f, the average metering is photometry that meters light over the entire surface of the frame image f and obtains the averaged value, and the multi-zone metering is photometry that meters light on individual partitioned regions of the frame image f.

The imaging condition adjuster 6c adjusts imaging conditions of an object set by the imaging controller 6 in response to a change in state of the imaged object. For example, the imaging condition adjuster 6c adjusts exposure adjustment conditions or white-balance adjustment conditions for the automatic exposure adjustment processing (AE) or the automatic white-balance adjustment processing (AWB) performed in the imaging controller 6 with reference to the state of the object detected by the state detector 6b.

For example, in the case of adjusting the exposure adjustment conditions for the automatic exposure adjustment processing (AE), the imaging condition adjuster 6c adjusts the aperture of the diaphragm of the lens section 1, the shutter speed of the electronic imaging section 2, and the signal amplification factor (ISO sensitivity) of the AGC of the unit circuit on the basis of a predetermined program diagram with reference to the brightness of the object detected by the state detector 6b. For example, in the case of adjusting the white-balance adjustment conditions for the automatic white-balance adjustment processing (AWB), the imaging condition adjuster 6c adjusts the amount of gain of each of the RGB color components of each pixel of the frame image f with reference to a color (color tone) of a gray component of the object detected by the state detector 6b.

Here, the imaging condition adjuster 6c may adjust the exposure adjustment conditions and the white-balance adjustment conditions alone or in combination, with reference to a particular object (for example, a human face area) detected by the object detector 5. For example, the imaging condition adjuster 6c may adjust the exposure adjustment conditions with reference to the brightness of the human face area detected by the object detector 5, or may adjust the white-balance adjustment conditions with reference to the color tone of the face area.

In this way, the imaging condition adjuster 6c adjusts the imaging conditions of an object in response to a change in state of the object during recording of moving image data of the object.

The imaging controller 6 controls the adjustment of the imaging conditions made by the imaging condition adjuster 6c in accordance with the recording frame rate. Specifically, the imaging controller 6 controls the imaging condition adjuster 6c to sequentially adjust the imaging conditions of the object to follow a change in state of the object during recording of the moving image at the normal recording frame rate (first recording frame rate). Specifically, the imaging controller 6 controls the imaging condition adjuster 6c to sequentially adjust the imaging conditions of the object such as the exposure adjustment conditions or the white-balance adjustment conditions to follow a change in state of the object for each frame image f (for example, a frame image f1) taken at a period corresponding to the normal recording frame rate.

In addition, when the recording frame rate is switched from the normal recording frame rate (first recording frame rate) to the high recording frame rate (second recording frame rate), the imaging controller 6 controls the adjustment of the imaging condition made by the imaging condition adjuster 6c so as to maintain a predetermined imaging condition determined before such switching of the recording frame rate. Specifically, when the recording frame rate is switched to the high recording frame rate (second recording frame rate) by the first recording-frame-rate setting section 6a in response to the predetermined user operation of the operation input section 11 during recording of a moving image at the normal recording frame rate (first recording frame rate), the imaging controller 6 maintains the imaging conditions of the object such as the exposure adjustment conditions or the white-balance adjustment conditions which are determined by the imaging condition adjuster 6c for the frame images f taken at the normal recording frame rate before such switching of the recording frame rate.

In this way, when the first recording-frame-rate setting section 6a switches the frame rate for recording the moving image from the first recording frame rate (for example, the normal recording frame rate) to the second recording frame rate higher than the first recording frame rate (for example, the high recording frame rate), the imaging controller 6 controls the adjustment of the imaging conditions made by the imaging condition adjuster 6c during recording of the moving image at the second recording frame rate.

When the recording frame rate is switched to the normal recording frame rate (first recording frame rate) in response to the predetermined user operation of the operation input section 11 during the recording of the moving image at the high recording frame rate (second recording frame rate), the imaging controller 6 may control the adjustment made by the imaging condition adjuster 6c such that a change in the recording state of the object is more moderate than the change before such switching of the recording frame rate for each frame image f (for example, frame image f3) taken at the normal recording frame rate.

Specifically, the imaging conditions of the object are maintained to the predetermined imaging conditions during recording of the moving image at the high recording frame rate. When follow-up of a change in state of the object to sequentially adjust the imaging conditions is resumed immediately after the recording frame rate is switched to the normal recording frame rate, a recording state of the object is rapidly changed. Thus, the imaging controller 6 controls the adjustment of the imaging conditions such that the recording state of the object is gradually changed for a while after the recording frame rate is switched to the normal recording frame rate, instead of resuming the adjustment of the imaging conditions, such as the exposure adjustment conditions or the white-balance adjustment conditions, immediately after the recording frame rate is switched to the normal recording frame rate.

This prevents the recording state of the object from being changed rapidly when the recording frame rate is switched to the normal recording frame rate, during recording of a moving image at the high recording frame rate.

The image processor 7 includes a coding section (not shown) that compresses/encodes the image data (YUV data) generated by the image generator 4 in a predetermined coding format (for example, Motion-JPEG format) and a decoding section (not shown) that decodes the coded image data read from the recording medium controller 10 with a decoding process corresponding to the coding process.

The display controller 8 reads out image data to be displayed from the buffer memory 12 that is temporarily stored in the buffer memory 12, and controls the display section 9 to display the image data.

Specifically, the display controller 8 includes a video random access memory (VRAM), a VRAM controller, and a digital video encoder. The digital video encoder reads out luminance signals Y and color-difference signals Cb and Cr of a plurality of frame images f, . . . constituting a moving image, which signals are read out from the buffer memory 12 and stored in the VRAM (not shown), from the VRAM through the VRAM controller at a predetermined reproduction frame rate, and generates a video signal on the basis of the data and outputs the video signal to the display section 9.

The “predetermined reproduction frame rate” is the same as the recording frame rate for recording the moving image data. Specifically, when moving image data is recorded at a recording frame rate of 30 fps corresponding to the normal moving image shooting, the display section 9 reproduces the moving image data at the reproduction frame rate of 30 fps, for example. On the other hand, when moving image data is recorded at a recording frame rate of 60 fps, the display section 9 reproduces the moving image data at the reproduction frame rate of 60 fps. Though moving image data can be reproduced at the same speed as actual speed in any reproduction frame rate, the data can be reproduced more smoothly (with less flicker) at a higher frame rate frequency (for example, 60 fps).

As described below, for moving image data whose recording frame rate is switched during the recording of the data, information of a recording frame rate set at the beginning of the recording is added to the moving image data as a recording frame-rate attribute of the data.

In reproducing the moving image data, the recording frame rate added as the recording frame-rate attribute is read out at the beginning of the reproduction, and the data is continuously reproduced at a reproduction frame rate fixed to the read recording frame rate from the beginning to the end of the reproduction.

In the case where the moving image is reproduced at a fixed reproduction frame rate in this way, apparent reproduction speed of the moving image varies depending on a change in a recording frame rate for input moving image data. For example, when the display controller 8 reproduces moving image data composed of a plurality of frame images f, . . . , which are taken at a period corresponding to the normal recording frame rate (for example, 30 fps), at a predetermined reproduction frame rate (for example, 30 fps), an imaging interval between the frame images f corresponds to a reproduction interval between the frame images f. In this case, the moving image seems to be reproduced at a normal reproduction speed. In addition, for example, when the display controller 8 reproduces moving image data composed of a plurality of frame images f, . . . , which are taken at a period corresponding to the high recording frame rate (for example, 240 fps), at a predetermined reproduction frame rate (for example, 30 fps), an imaging interval between the frame images f is shorter than a reproduction interval between the frame images f. In this case, the moving image seems to be reproduced in slow-motion. That is, the display controller 8 continuously reproduces the entire moving image data at the same frame rate as the first recording frame rate without switching of the reproduction frame rate between a portion recorded at the first recording frame rate and a portion recorded at the second recording frame rate. Thereby, the portion recorded at the second recording frame rate is automatically reproduced in slow motion.

In this way, in the case where the display controller 8 reproduces the moving image data recorded at a recording frame rate, which is temporarily switched to a certain frame rate (for example, 240 fps) by the first recording-frame-rate setting section 6a, the display controller 8 controls a portion of the data, which portion is recorded at the temporarily switched recording frame rate, to be reproduced at a frame rate (for example, 30 fps) different from the certain recording frame rate (for example, 240 fps).

In the first embodiment, the reproduction frame rate is fixed so as to allow the relevant portion to be automatically reproduced in slow motion when a recording frame rate is partially switched during recording of the moving image data. Alternatively, the reproduction frame rate may be changed in accordance with a change in the recording frame rate such that the reproduction frame rate corresponds to an actual time. In such a case, partial smooth reproduction is achieved instead of partial slow-motion reproduction.

Alternatively, a user may optionally select one of these two reproduction methods through selection of a reproduction mode.

The display section 9 includes, for example, a liquid crystal display panel, and displays an image taken by the electronic imaging section 2 on its screen on the basis of the video signal from the display controller 8. Specifically, the display section 9 displays a live view image in a still image shooting mode or a moving image shooting mode while sequentially updating a plurality of frame images f, . . . , which are generated through imaging of an object by the electronic imaging section 2 and the imaging controller 6, at a predetermined frame rate. In addition, the display section 9 displays a plurality of frame images f, . . . that are being recorded as a moving image, or displays an image recorded as a still image (Rec-View image).

The recording medium controller 10 has the recording medium M removably installed therein, and controls read and write of data from/to the recording medium M.

Specifically, the recording medium controller 10 stores recording image data, coded in a predetermined compression format (for example, Motion-JPEG format) by a coding section (not shown) of the image processor 7, into the recording medium M as a series of moving image data. In other words, the recording medium controller 10 stores a moving image of the object composed of a plurality of frame images, which are sequentially taken by the lens section 1, the electronic imaging section 2, and the unit circuit 3, into the recording medium M as a series of moving image data.

The recording medium M is composed of, for example, a nonvolatile memory (flash memory). However, this is illustrative only and can be modified as required.

The operation input section 11 receives predetermined operations for the imaging apparatus 100. Specifically, the operation input section 11 includes a shutter button 11a that can be half-pressed or full-pressed for a shooting instruction of an object, a selection determination button 11b for an instruction for selecting an imaging mode or a function, and a zoom button (not shown) for an adjustment instruction of a zoom rate. The operation input section 11 outputs predetermined operational signals to the central controller 14 in response to the operation of these buttons.

The buffer memory 12 functions as a buffer that temporarily stores the image data and as a working area of the central controller 14.

The program memory 13 stores programs and data relevant to the functions of the imaging apparatus 100.

The central controller 14 controls the sections of the imaging apparatus 100. Specifically, the central controller 14 includes CPU (not shown) for controlling the sections of the imaging apparatus 100, and performs various control operations in accordance with various processing programs (not shown).

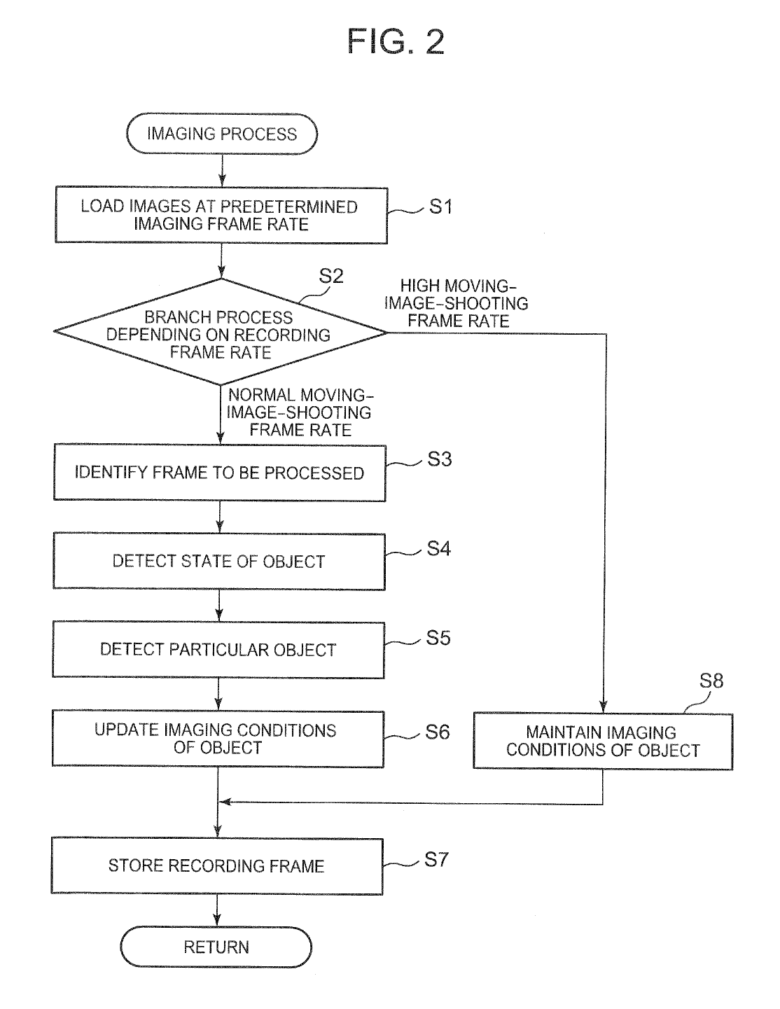

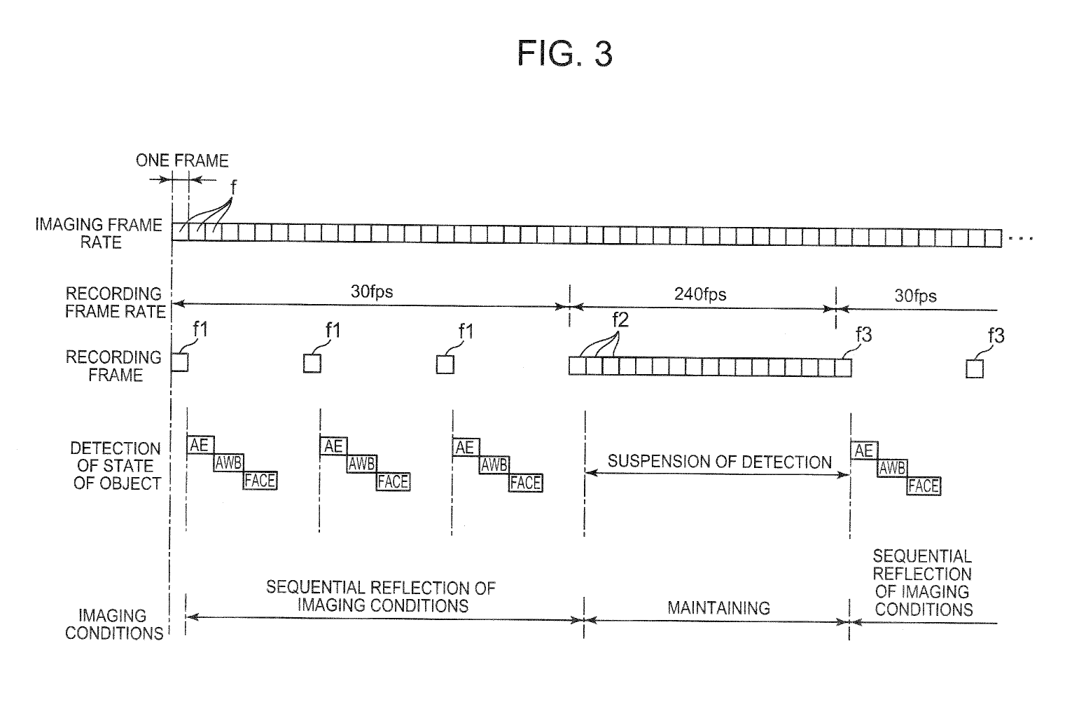

The imaging process performed by the imaging apparatus 100 is now described with reference to FIGS. 2 and 3.

FIG. 2 is a flowchart illustrating an exemplary operation according to the imaging process. FIG. 3 illustrates the imaging process.

The following imaging process is performed in response to an instruction for selecting the moving image shooting mode among a plurality of imaging modes input by a user with the selection determination button 11b of the operation input section 11. The imaging process starts upon input of a moving-image shooting instruction, and processing of each step is repeated until input of an instruction for ending the moving image shooting.

As shown in FIG. 2, the imaging controller 6 drives the electronic imaging section 2 at a predetermined imaging frame rate (for example, 240 fps) to convert an optical image of an object formed by the lens section 1 to two-dimensional image signals (RGB image data) so as to load frame images f (step S1).

Then, the imaging controller 6 branches the process depending on the recording frame rates (step S2). Specifically, when the recording frame rate corresponds to the normal moving image shooting (for example, 30 fps) (step S2; normal moving-image-shooting frame rate), the imaging controller 6 shifts the process to step S3. When the recording frame rate corresponds to the high-speed moving image shooting (for example, 240 fps) (step S2; high-speed moving-image-shooting frame rate), the imaging controller 6 shifts the process to step S8.

### <Normal Moving-Image-Shooting Frame Rate>

In step S2, when the recording frame rate corresponds to the normal moving image shooting (for example, 30 fps) (step S2; normal moving-image-shooting frame rate), the imaging controller 6 extracts certain frame images f (for example, frame images f1; see FIG. 3) from frame images f sequentially loaded at a predetermined imaging frame rate (for example, 240 fps) (in this exemplary case, selects the certain frame images at a rate of one in eight) according to the recording frame rate for the normal moving image shooting, and identifies the extracted frame images f as the frame images f to be processed (step S3). Specifically, the processes of steps S4 to S7 described below are skipped for the frame images f that are not extracted, but are performed for the extracted frame images f (frame images f selected to be processed). The imaging controller 6 performs such a identifying process and thus converts the analog image signal output from the electronic imaging section 2 to a digital image signal at a predetermined period corresponding to the recording frame rate of the normal moving image shooting in the unit circuit 3. The image generator 4 generates digital luminance signals Y and digital color-difference signals Cb and Cr (YUV data) from digital image signals of the frame images f to be processed transmitted from the unit circuit 3.

Then, the state detector 6b of the imaging controller 6 detects a state of the object on the basis of the image data (YUV data) of the luminance/color-difference signals of the frame images f to be processed input from the image generator (step S4). Specifically, the state detector 6b detects brightness of frame images f to be processed that are to be used for the automatic exposure adjustment processing (AE) performed in the imaging controller 6 according to a predetermined photometric process, and detects a color tone (gray component) of frame images f to be processed that are to be used for the automatic white-balance adjustment processing (AWB) on the basis of a gray pixel estimation condition corresponding to a color temperature of a predetermined light source (for example, sunlight).

Then, the object detector 5 performs various types of image processes such as a face detection process, an edge detection process, and a feature extraction process to the image data (YUV data) of each frame image f input from the image generator 4 to detect an area including the particular object (for example, a face area) (step S5).

The detection of the state of the object of step S4 may be performed with reference to a particular object (for example, a face area) detected in a frame image f that is stored prior to the frame images f to be processed.

The process order may be exchanged between the object-state detection process of step S4 and the particular-object detection process of step S5. In such a case, brightness or a color tone of a frame image f to be processed may be detected with reference to a particular object detected in the frame image f to be processed.

Then, the imaging condition adjuster 6c of the imaging controller 6 adjusts the imaging conditions of the object set by the imaging controller 6 with reference to the state of the object detected by the state detector 6b to update the content of the imaging conditions stored in the predetermined memory area (step S6). Specifically, the imaging condition adjuster 6c adjusts the exposure adjustment conditions or the white-balance adjustment conditions for the automatic exposure adjustment processing (AE) or the automatic white-balance adjustment processing (AWB) performed in the imaging controller 6 with reference to the state of the object detected by the state detector 6b. The imaging condition adjuster 6c updates the content of the imaging conditions stored in the predetermined memory area in accordance with the adjusted exposure adjustment conditions or white-balance adjustment conditions.

As a result, frame images f, which are stored after the processed image frame f, reflect the updated imaging conditions.

Then, the central controller 14 identifies the frame images f to be processed generated by the image generator 4 as the recording frame images f, and stores the YUV data of the frame images f in the buffer memory 12 (step S7). That is, in the case of the normal moving-image-shooting frame rate, the frame images f selected at a rate of one in eight from the frame images f, which are sequentially loaded at 240 fps, are stored in the buffer memory 12 at a recording frame rate of 30 fps.

### <High-Speed Moving-Image-Shooting Frame Rate>

In step S2, when the recording frame rate corresponds to the high-speed moving image shooting (for example, 240 fps) (step S2; high-speed moving-image-shooting frame rate), the imaging controller 6 controls the adjustment made by the imaging condition adjuster 6c such that the recording frame maintains the imaging conditions determined prior to the switching to the high recording frame rate (step S8). Specifically, the imaging controller 6 controls the adjustment to maintain the imaging conditions of the object such as the exposure adjustment conditions or the white-balance adjustment conditions, which are sequentially adjusted by the imaging condition adjuster 6c and stored in a predetermined memory area, for the frame images f taken at a period corresponding to the normal recording frame rate before the switching to the high recording frame rate.

The central controller 14 then shifts the process to step S7, and identifies the frame images f (for example, the frame images f2; see FIG. 3), which are taken at a period corresponding to the high recording frame rate and generated by the image generator 4, as the recording frame images f, and stores the YUV data of the identified frame images f in the buffer memory (step S7). That is, in the case of the high-speed moving-image-shooting frame rate, all the frame images f that are sequentially loaded at 240 fps are stored in the buffer memory 12 at a recording frame rate of 240 fps without removing a part of the frame images.

These processing steps are repeated until an instruction for ending the moving image shooting is input.

Upon the input of the instruction for ending the moving image shooting, the recording medium controller 10 determines a recording frame rate (in the exemplary case, 30 fps), which is set at the beginning of the recording of the moving image data, as a recording frame-rate attribute, and adds the attribute to the moving image data stored in the buffer memory 12, and stores the moving image data having the attribute in the recording medium M.

As described above, according to the imaging apparatus 100 of the first embodiment, imaging conditions are adjusted to follow a change in state of an object so as to keep the exposure or white balance suitable for the state of the object at any time during moving image shooting, as a whole. When a frame rate is partially switched from the normal frame rate (first recording frame rate) to the higher frame rate (second recording frame rate) during the moving image shooting, images are taken and recorded such that a change in the imaging conditions is controlled. As a result, when the entire moving image data is reproduced at a constant reproduction speed, the exposure or white balance is suitably adjusted according to a situation of an object as a whole. Further, an image at a decisive moment can be automatically reproduced in slow motion without needing for an instruction operation by a user, and thereby, detailed motion of a main object can be checked. Still further, brightness or a color tone of the main object can also be checked appropriately during the slow-motion reproduction.

For example, in the case where the imaging apparatus 100 is panned for imaging in a photometric method in consideration of brightness on the entire frame image f, brightness or a color tone of the main object can be prevented from being changed due to a change in a background when there is no change in state of the main object, and the brightness or the color tone of the main object can be appropriately checked in reproducing the moving image at a predetermined reproduction frame rate later. In addition, for example, in the case where a rotating main-object is imaged in a photometric method with reference to brightness of the main object, imaging conditions of the object are prevented from being changed in response to a change in light reflectivity caused by the rotation of the main object, and thus the light reflectivity of the main object can be appropriately checked in reproducing the moving image at a predetermined reproduction frame rate later.

In the first embodiment, when the recording frame rate is switched to the high recording frame rate, the detection of the state of the object (step S4) and the detection of the particular object (step S5) are not performed. This however is not limitative, and the detection processing of the object state and the detection of the particular object may be performed without reflecting the imaging conditions. In this case, for example, among a plurality of frame images f, . . . constituting a moving image, a certain frame image f may be identified to be processed every predetermined interval in consideration of time necessary for execution of the detection of the object state and of the detection of the particular object.

In the embodiment, when the recording frame rate is switched to the high recording frame rate, imaging conditions prior to the switching of the recording frame rate are maintained. This however is not limitative, and the imaging conditions of the object may be adjusted by the imaging condition adjuster 6c such that the recording state of the object is gradually changed.

For example, frame images f, which are taken every predetermined interval longer than the interval corresponding to the high recording frame rate, are identified to be processed among a plurality of frame images f, . . . constituting a moving image, and the detection of the object state and the detection of the particular object are performed to the identified frame images f. Then, the imaging condition adjuster 6c adjusts the imaging conditions of the object such as the exposure adjustment conditions or the white-balance adjustment conditions with reference to the state of the object detected by the state detector 6b at a predetermined interval or with reference to the particular object (for example, a human face area) detected by the object detector 5. Here, the imaging controller 6 controls the imaging condition adjuster 6c to adjust the imaging conditions of the object such that the recording state of the object is gradually changed, instead of controlling the imaging condition adjuster 6c to adjust the imaging conditions of the object such as the exposure adjustment conditions or the white-balance adjustment conditions to follow a sequential change in state of the object. For example, the imaging controller 6 makes adjustment such that the imaging conditions are gradually changed from first imaging conditions determined by the imaging condition adjuster 6c according to a state of the object detected in a preceding frame image f to second imaging conditions determined by the imaging condition adjuster 6c according to a state of the object detected in the succeeding frame image f between two frame images f and f taken at a predetermined interval, for at least one pair of frame images f. For example, for two frame images f and f taken at a predetermined interval, when the variation between the second imaging conditions and the first imaging conditions is greater than a predetermined rate, the imaging controller 6 controls the variation to be reduced by a predetermined rate.

This prevents rapid change in the recording state of the moving image recorded at the high recording frame rate, so that the state of the main object can be appropriately checked.

### Second Embodiment

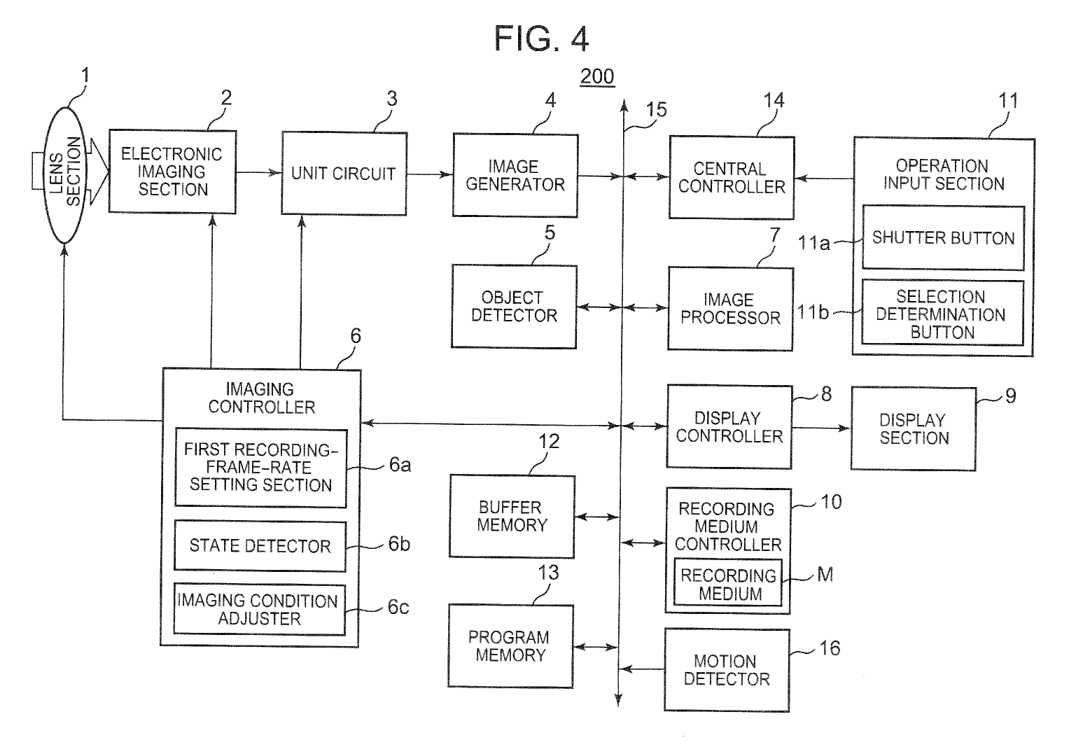

FIG. 4 is a block diagram illustrating a schematic configuration of an imaging apparatus 200 according to a second embodiment of the present invention.

The imaging apparatus 200 according to the second embodiment has substantially the same configuration as that of the imaging apparatus 100 of the first embodiment except for the point described in detail below, and detailed description of the configuration is omitted.

During recording of a moving image at a high recording frame rate, the imaging apparatus 200 of the second embodiment adjusts the imaging conditions of an object such that the recording state of the object is gradually changed in the case where the magnitude of motion, which occurs in the apparatus and causes a change in a shooting direction, is larger than a predetermined value.

Specifically, as shown in FIG. 4, the imaging apparatus 200 includes a lens section 1, an electronic imaging section 2, a unit circuit 3, an image generator 4, a state detector 6b, an imaging controller 6, an image processor 7, a display controller 8, a display section 9, a recording medium controller 10, an operation input section 11, a buffer memory 12, a program memory 13, a central controller 14, and a motion detector 16.

The motion detector 16 detects the magnitude of the motion occurring in the imaging apparatus 200.

Specifically, the motion detector 16 includes, for example, a motion detection sensor (not shown) such as an acceleration detection sensor or an angular-velocity detection sensor. The motion detector 16 identifies motion information such as the magnitude of the motion (tremor), which occurs in the apparatus and causes a change in a shooting direction, on the basis of an output signal from the motion detection sensor.

The motion detector 16 may detect the motion speed instead of the magnitude of motion on the basis of an output signal from the motion detection sensor.

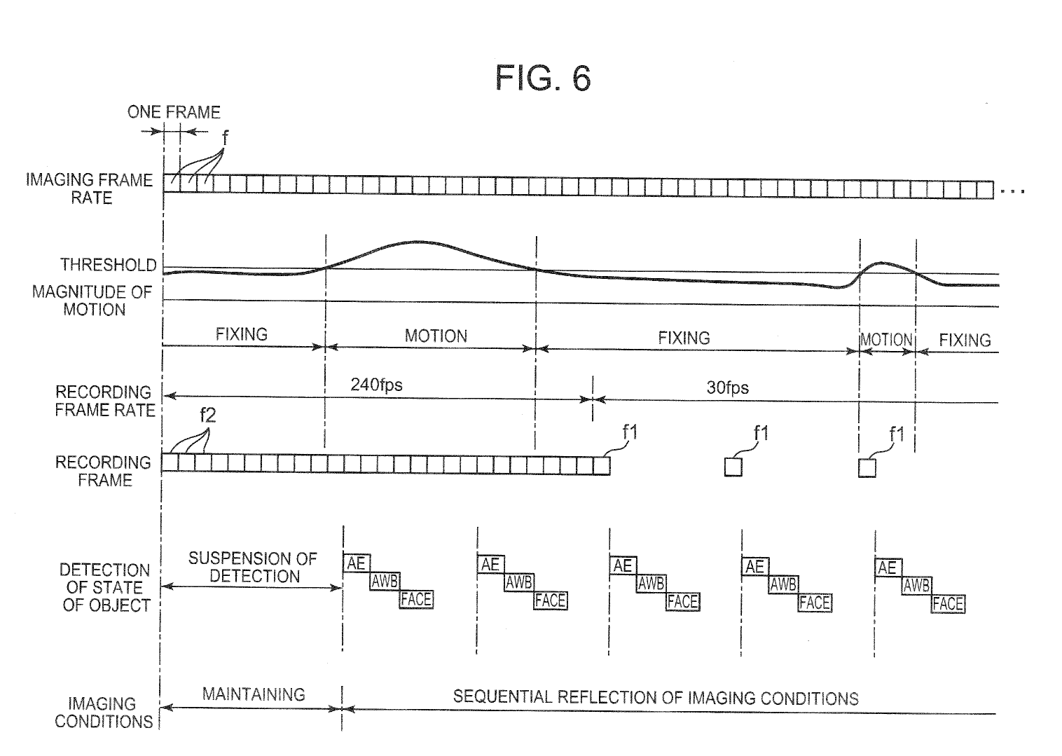

During recording of a moving image at a recording frame rate (for example, 240 fps) corresponding to the high-speed moving image shooting, the imaging controller 6 determines whether the magnitude of motion, which occurs in the apparatus and is detected by the motion detector 16, is larger than a predetermined threshold or not. When the magnitude of motion occurring in the apparatus is larger than the predetermined threshold, the state detector 6b of the imaging controller 6 identifies certain frame images f (for example, frame images f2; see FIG. 6), which are taken at a predetermined interval longer than the interval (for example, 1/240 sec) corresponding to the high recording frame rate, as frame images to be processed, among a plurality of frame images f, . . . constituting a moving image; and detects a state of the object in the identified frame images f.

Here, the object detector 5 may identify certain frame images f, which are taken at predetermined intervals longer than the interval corresponding to the high recording frame rate, as frame images to be processed; and may detect the particular object in the identified frame images f.

When the imaging controller 6 determines that the magnitude of motion, which occurs in the apparatus and is detected by the motion detector 16, is larger than the predetermined threshold during recording of the moving image at a high recording frame rate, the controller 6 controls the imaging condition adjuster 6c to adjust the imaging conditions of the object such that the recording state of the object is gradually changed instead of adjusting the imaging conditions of the object to sequentially follow a change in state of the object for the frame images f taken at the predetermined interval longer than the interval corresponding to the high recording frame rate.

Specifically, the imaging condition adjuster 6c of the imaging controller 6 adjusts the imaging conditions of the object such as the exposure adjustment conditions or the white-balance adjustment conditions with reference to the state of the object detected by the state detector 6b at the predetermined interval for the frame images f taken at the predetermined interval longer than the interval corresponding to the high recording frame rate. Here, the imaging controller 6 controls the imaging condition adjuster 6c to adjust the imaging conditions to be gradually changed from first imaging conditions determined by the imaging condition adjuster 6c according to a state of the object detected in a preceding frame image f to second imaging conditions determined by the imaging condition adjuster 6c according to a state of the object detected in a succeeding frame image f between the two frame images f and f taken at a predetermined interval for at least one pair of frame images f.

For example, for the two frame images f and f taken at the predetermined interval, when the second imaging conditions determined by the imaging condition adjuster 6c on the basis of the succeeding frame image f vary at a predetermined rate or more with respect to the first imaging conditions determined by the imaging condition adjuster 6c on the basis of the preceding frame image f, the imaging controller 6 controls the variations in the second imaging conditions determined by the imaging condition adjuster 6c on the basis of the succeeding frame image f to decrease by a predetermined rate.

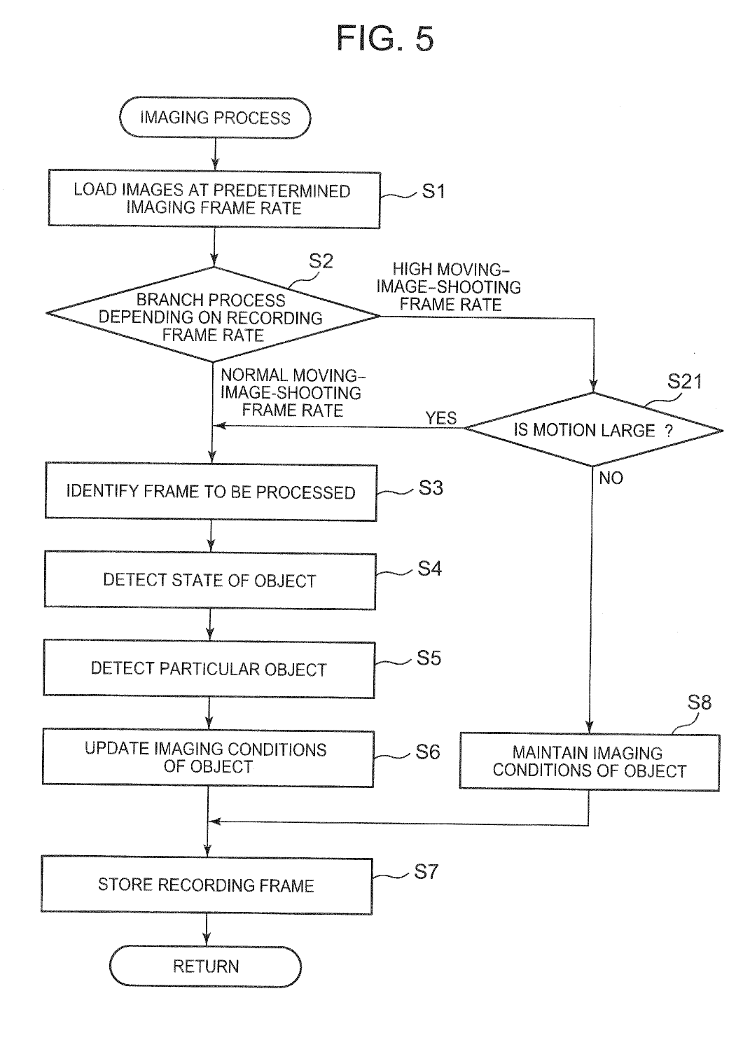

The imaging process performed by the imaging apparatus 200 is now described with reference to FIGS. 5 and 6.

FIG. 5 is a flowchart illustrating an exemplary operation according to the imaging process. FIG. 6 illustrates the imaging process.

The following imaging process according to the second embodiment is substantially the same as that in the first embodiment except for the determination processing on the magnitude of motion occurring in the apparatus, and detailed description of the imaging process is omitted.

As shown in FIG. 5, first, the imaging controller 6 drives the electronic imaging section 2 at a predetermined imaging frame rate (for example, 240 fps) to convert an optical image of an object formed by the lens section 1 to two-dimensional image signals (RGB image data) so as to load the frame images f (step S1), as in the imaging process of the first embodiment.

The imaging controller 6 then branches the process depending on the recording frame rates as in the imaging process of the first embodiment (step S2).

### <Normal Moving-Image-Shooting Frame Rate>

When the recording frame rate corresponds to the normal moving image shooting (for example, 30 fps) (step S2; normal moving-image-shooting frame rate), the processes of steps S3 to S7 are performed as in the imaging process of the first embodiment.

Specifically, the imaging controller 6 extracts certain frame images f (for example, frame images f1; see FIG. 6) from frame images f sequentially loaded at a predetermined imaging frame rate (for example, 240 fps) (in this exemplary case, selects the certain frame images at a rate of one in eight) according to the recording frame rate of the normal moving image shooting and identifies the certain frame images f as frame images f to be processed (step S3). The state detector 6b of the imaging controller 6 then detects a state of the object on the basis of the image data (YUV data) of the luminance/color-difference signals of the frame images f to be processed input from the image generator 4 (step S4). The object detector 5 then performs various types of image processes to the image data (YUV data) of each frame image f input from the image generator 4 at a predetermined period corresponding to the recording frame rate of the normal moving image shooting to detect an area including the particular object (for example, a face area) (step S5).

The imaging condition adjuster 6c of the imaging controller 6 then adjusts the imaging conditions of the object set by the imaging controller 6 with reference to the state of the object detected by the state detector 6b to update the content of the imaging conditions stored in a predetermined memory area (step S6).

The central controller 14 then identifies the frame images f to be processed, which are generated by the image generator 4 at the predetermined period corresponding to the recording frame rate of the normal moving image shooting, as the recording frame images f, and stores the YUV data of the frame images f in the buffer memory 12 (step S7).

### <High-Speed Moving-Image-Shooting Frame Rate>

In step S2, When the recording frame rate corresponds to the high-speed moving image shooting (for example, 240 fps) (step S2; high-speed moving-image-shooting frame rate), the imaging controller 6 determines whether the magnitude of motion, which occurs in the apparatus and is detected by the motion detector 16, is larger than the predetermined threshold or not (step S21). For example, the imaging controller 6 determines whether motion, whose magnitude is larger than the predetermined threshold, occurs in the imaging apparatus 200 due to pan operation of the apparatus in a predetermined direction, or the apparatus is fixed in a normal state.

In step S21, when the imaging controller 6 determines that the magnitude of motion occurring in the apparatus is not larger than the predetermined threshold (step S21; NO), the imaging controller 6 controls the adjustment made by the imaging condition adjuster 6c such that the imaging conditions determined prior to the switching to the high recording frame rate are maintained, as in the imaging process of the first embodiment (step S8).

The central controller 14 then shifts the process to step S7, and identifies frame images f, which are taken at the predetermined period corresponding to the high recording frame rate and generated by the image generator 4, as the recording frame images f and stores the YUV data of the identified frame images f in the buffer memory 12 (step S7).

In step S21, when the imaging controller 6 determines that the magnitude of motion occurring in the apparatus is larger than the predetermined threshold (step S21; YES), the controller 6 shifts the process to step S3, and extracts certain frame images f from frame images f sequentially loaded at a predetermined imaging frame rate (for example, 240 fps) under a predetermined condition (in this exemplary case, selects the extracted frame images at a rate of one in eight), and identifies the extracted frame images f as the frame images f to be processed (step S3). Specifically, the imaging controller 6 identifies the frame images f, which are taken at the predetermined interval longer than the interval corresponding to the high recording frame rate, as frame images to be processed among frame images f sequentially loaded at the predetermined imaging frame rate (for example, 240 fps).

The state detector 6b of the imaging controller 6 then detects a state of the object on the basis of the image data (YUV data) of the luminance/color-difference signals of the frame images f to be processed input from the image generator 4 (step S4), and the object detector 5 performs various types of image processes to the image data (YUV data) of each frame image f input from the image generator 4 to detect an area including the particular object (for example, a face area) (step S5), as in the imaging process of the first embodiment.

Then, the imaging condition adjuster 6c of the imaging controller 6 adjusts the imaging conditions of the object set by the imaging controller 6 with reference to the state of the object detected by the state detector 6b to update the content of the imaging conditions stored in the predetermined memory area (step S6).

Here, the imaging controller 6 controls the imaging condition adjuster 6c to adjust the imaging conditions of the object such that the recording state of the object in a moving image is gradually changed for the frame images f taken at the predetermined interval longer than the interval corresponding to the high recording frame rate. Specifically, the imaging controller 6 controls the imaging condition adjuster 6c to adjust the imaging conditions such that the imaging conditions are gradually changed from first imaging conditions determined by the imaging condition adjuster 6c according to a state of the object detected in a preceding frame image f to second imaging conditions determined by the imaging condition adjuster 6c according to a state of the object detected in a succeeding frame image f between two frame images f and f taken at the predetermined interval for at least one pair of frame images f.

Then, the central controller 14 shifts the process to step S7, and identifies the frame images f, which are taken at a period corresponding to the high recording frame rate and generated by the image generator 4, as the recording frame images f, and stores the YUV data of the identified frame images f in the buffer memory 12 (step S7), as in the described above.

These processing steps are repeated until an instruction for ending the moving image shooting is input.

As described above, according to the imaging apparatus 200 of the second embodiment, when the magnitude of the motion occurring in the apparatus is larger than the predetermined threshold during recording of the moving image at the second high recording frame rate, the imaging conditions of the object are adjusted such that the recording state of the object is gradually changed for the frame images f taken at the predetermined interval longer than the interval corresponding to the second recording frame rate, and thus imaging conditions of the object can be adjusted in consideration of a change in state of the object in response to a change in a background when a motion of the apparatus is large. This prevents a variation in a recording state of the object in response to a variation in the imaging conditions of the object in the case where the apparatus is fixed to check the brightness or a color tone of a main object to be imaged. That is, the brightness or the color tone of the main object can be appropriately checked during slow-motion reproduction of an image at a decisive moment.

In the case where the apparatus itself is greatly moved, for example, the imaging apparatus 200 is panned for imaging, checking the brightness or the color tone of the main object is not very important, and thus the imaging conditions of the object can be adjusted in consideration of a change in state of the object in response to a change in a background. That is, a picture can be viewed with an exposure or a white balance suited for a situation of the object during reproduction of the moving image data.

Here, the imaging conditions of the object are adjusted to be gradually changed from the first imaging conditions determined according to a state of the object detected in a preceding frame image f to the second imaging conditions determined according to a state of the object detected in a succeeding frame image f between two frame images f and f taken at the predetermined interval longer than the interval corresponding to the second recording frame rate. This prevents the recording state of the object, such as the brightness or the color tone of the main object, from being rapidly changed during recording of a moving image at the high recording frame rate. As a result, the brightness or the color tone of the main object can be appropriately checked in consideration of a change in state of the object in response to a change in a background while the recording state of the object, including the brightness or the color tone of the main object, is not rapidly changed during the reproduction of the moving image at a predetermined reproduction frame rate.

In the second embodiment, for example, in the case where the imaging apparatus 200 is fixed on a tripod so that the magnitude of the motion occurring in the apparatus does not exceed the predetermined threshold, the state detector 6b can skip the detection of the gray component (color tone) of the frame images f to be processed used for automatic white-balance adjustment processing (AWB) performed in the imaging controller 6, and thus the imaging condition adjuster 6c can skip the adjustment of the white-balance adjustment conditions for the automatic white-balance adjustment processing (AWB). For example, in the case where the apparatus is fixed on a tripod, various types of processes relevant to the automatic white-balance adjustment processing (AWB) can be omitted on the assumption of no change in a light source, leading to high-speed imaging processing and reduction in energy consumption.

### Third Embodiment

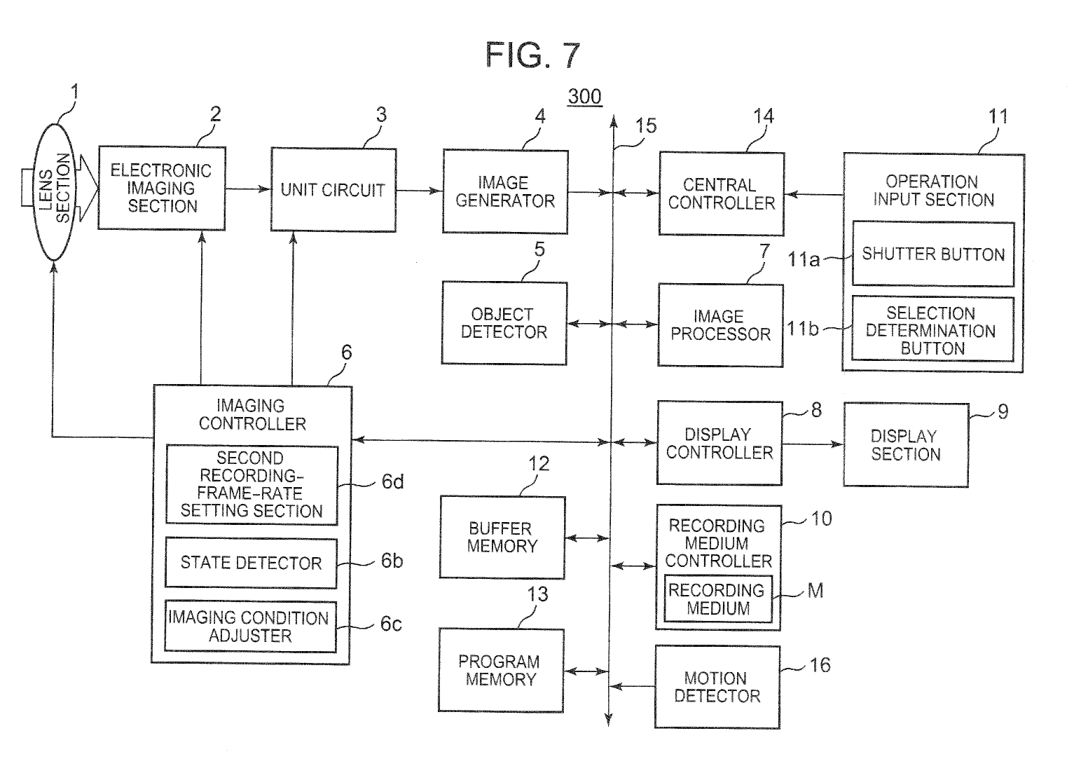

FIG. 7 is a block diagram illustrating a schematic configuration of an imaging apparatus 300 according to a third embodiment of the present invention.

The imaging apparatus 300 according to the third embodiment has substantially the same configuration as that of the imaging apparatus 200 of the second embodiment except for the point described in detail below, and the detailed description of the configuration is omitted.

In the imaging apparatus 300 according to the third embodiment, a predetermined moving image operation mode may be set so that the frame rate is automatically switched during shooting and recording of a moving image. In such a case, when the magnitude of the motion occurring in the apparatus is larger than the predetermined threshold, a moving image is taken at a predetermined period corresponding to the first normal recording frame rate. When the magnitude of the motion occurring in the apparatus is not larger than the predetermined threshold, the frame rate is automatically switched to the second high recording frame rate.

Specifically, the imaging controller 6 of the imaging apparatus 300 includes a second recording-frame-rate setting section 6d as shown in FIG. 7.

The second recording-frame-rate setting section 6d switches the recording frame rate depending on the magnitude of the motion occurring in the apparatus.

Specifically, the second recording-frame-rate setting section 6d determines whether the magnitude of the motion, which occurs in the apparatus and is detected by the motion detector 16, is larger than the predetermined threshold or not. When the second recording-frame-rate setting section 6d determines the magnitude of the motion is larger than the predetermined threshold, the section 6d switches the recording frame rate to a recording frame rate (first recording frame rate) corresponding to the normal moving image shooting. When the section 6d determines the magnitude of the motion is not larger than the predetermined threshold, the section 6d switches the recording frame rate to a recording frame rate (second recording frame rate) corresponding to the high-speed moving image shooting.

The imaging controller 6 drives the unit circuit 3 at a predetermined timing corresponding to a recording frame rate (for example, second high recording frame rate) switched by the second recording-frame-rate setting section 6d to convert an analog image signal corresponding to an optical image of the object input from the electronic imaging section 2 to a digital image signal (frame images f).

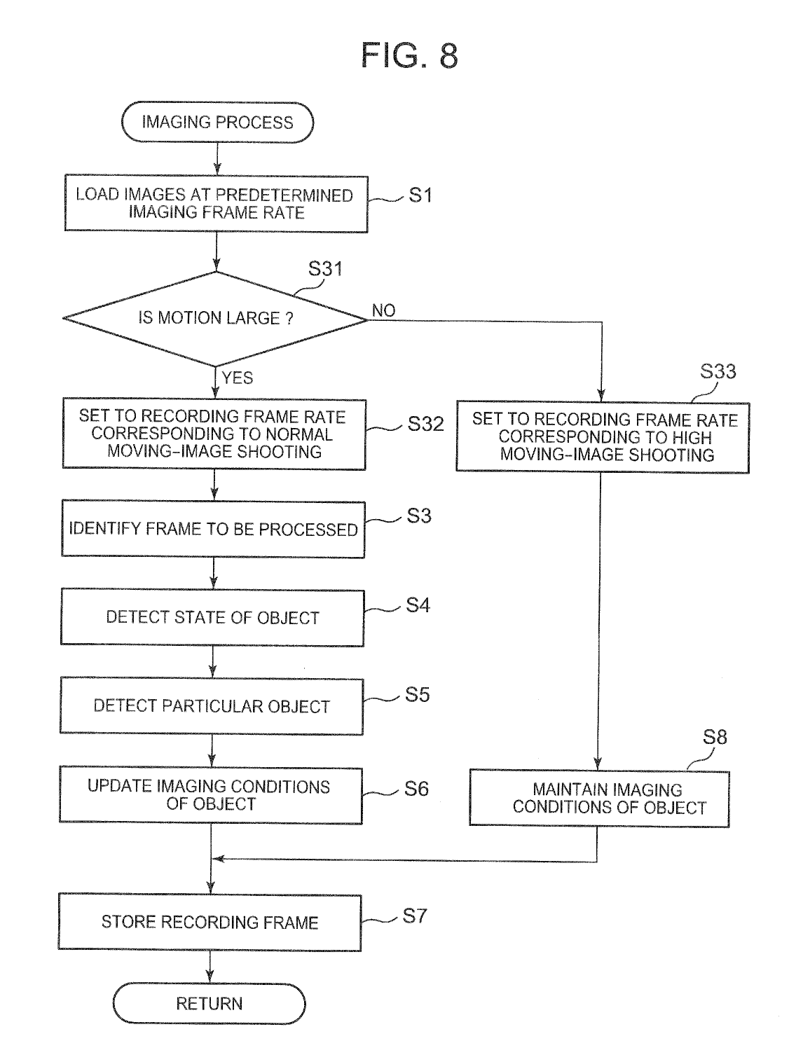

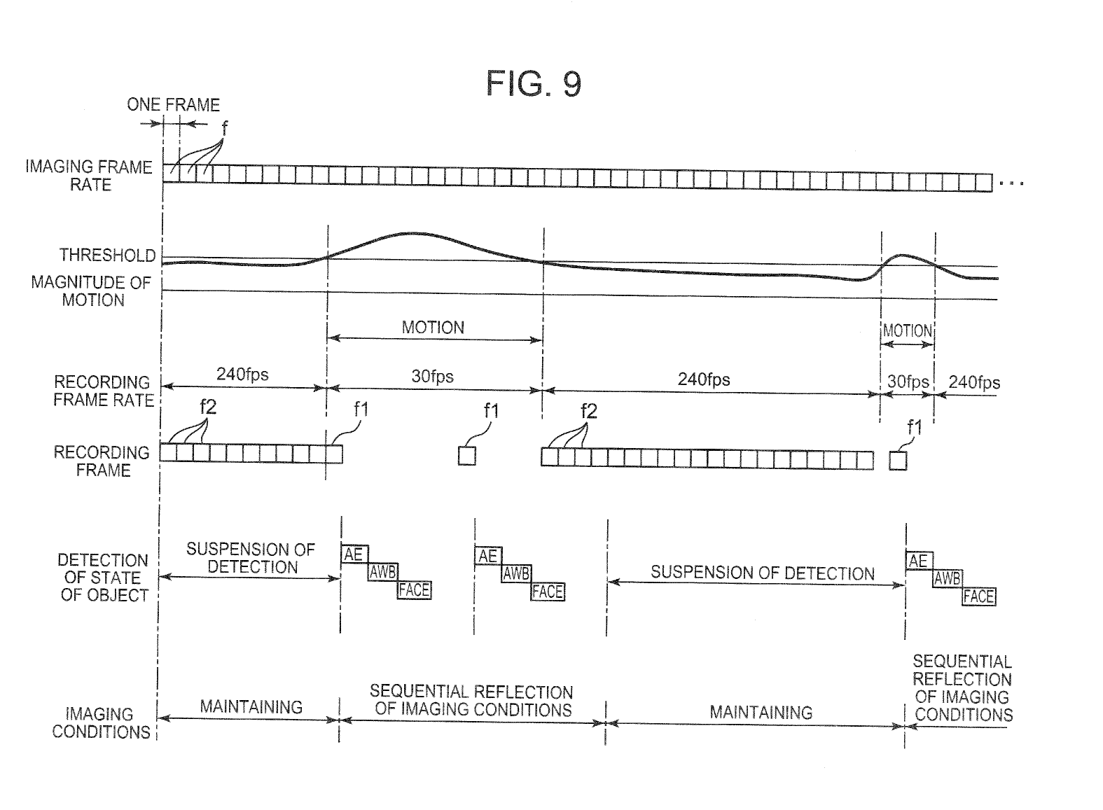

The imaging process performed by the imaging apparatus 300 is now described with reference to FIGS. 8 and 9.

FIG. 8 is a flowchart illustrating an exemplary operation according to the imaging process. FIG. 9 illustrates the imaging process.

The following imaging process according to the third embodiment is substantially the same as that in the first embodiment except that the recording frame rate is switched depending on the magnitude of the motion occurring in the apparatus, and the detailed description of the imaging process is omitted.

As shown in FIG. 8, the imaging controller 6 drives the electronic imaging section 2 at a predetermined imaging frame rate (for example, 240 fps) to convert an optical image of an object formed by the lens section 1 to two-dimensional image signals (RGB image data) so as to load the frame images f (step S1), as in the imaging process of the first embodiment.

The second recording-frame-rate setting section 6d determines whether the magnitude of the motion, which occurs in the apparatus and is detected by the motion detector 16, is larger than the predetermined threshold or not (step S31). For example, the second recording-frame-rate setting section 6d determines whether the motion, whose magnitude is larger than the predetermined threshold, occurs in the imaging apparatus 300 due to pan operation of the apparatus in a predetermined direction.

In step S31, when the second recording-frame-rate setting section 6d determines that the magnitude of the motion occurring in the apparatus is larger than the predetermined threshold (step S31; YES), the section 6d sets the recording frame rate to the normal recording frame rate (step S32).

Then, each process of steps S3 to S7 is performed as in the imaging process of the first embodiment.

Specifically, the imaging controller 6 extracts certain frame images f (for example, frame images f1; see FIG. 9) from frame images f sequentially loaded at a predetermined imaging frame rate (for example, 240 fps) (in this exemplary case, selects the certain frame images at a rate of one in eight) according to the recording frame rate of the normal moving image shooting and identifies the certain frame images f as frame images f to be processed (step S3). The state detector 6b of the imaging controller 6 then detects a state of the object on the basis of the image data (YUV data) of the luminance/color-difference signals of the frame images f to be processed input from the image generator 4 (step S4). The object detector 5 then performs various types of image processes to the image data (YUV data) of each frame image f input from the image generator 4 at a predetermined period corresponding to the recording frame rate of the normal moving image shooting to detect an area including the particular object (for example, a face area) (step S5).

The imaging condition adjuster 6c of the imaging controller 6 then adjusts the imaging conditions of the object set by the imaging controller 6 with reference to the state of the object detected by the state detector 6b to update the content of the imaging conditions stored in a predetermined memory area (step S6).

The central controller 14 then identifies the frame images f to be processed, which are generated by the image generator 4 at the predetermined period corresponding to the recording frame rate of the normal moving image shooting, as the recording frame images f, and stores the YUV data of the frame images f in the buffer memory 12 (step S7).

In step S31, when the second recording-frame-rate setting section 6d determines that the magnitude of the motion occurring in the apparatus is not larger than the predetermined threshold (step S31; NO), the section 6d sets the recording frame rate to the high recording frame rate (step S33).

The imaging controller 6 controls the adjustment made by the imaging condition adjuster 6c such that the imaging conditions determined prior to the switching to the high recording frame rate are maintained, as in the imaging process of the first embodiment, as in the imaging process of the first embodiment (step S8).

Then, the central controller 14 shifts the process to step S7, and identifies the frame images f, which are taken at a period corresponding to the high recording frame rate and generated by the image generator 4, as the recording frame images f (for example, frame images f2 in FIG. 9), and stores the YUV data of the identified frame images f in the buffer memory 12 (step S7).

These processing steps are repeated until an instruction for ending the moving image shooting is input.

As described above, according to the imaging apparatus 300 of the third embodiment, when the magnitude of the motion occurring in the apparatus is not larger than the predetermined threshold, a moving image is taken at a predetermined period corresponding to the second high recording frame rate. When the magnitude of the motion is larger than the predetermined threshold, a moving image is taken at a predetermined period corresponding to the first normal recording frame rate. As a result, the recording frame rate can be automatically switched depending on the magnitude of the motion occurring in the apparatus.

When a predetermined user operation of the operation input section 11 is required to switch the recording frame rate, the apparatus inconveniently moves due to the user operation, leading to formation of a blurred image. Thus, the recording frame rate is automatically switched depending on the magnitude of the motion occurring in the apparatus. This eliminates the need for predetermined user operation of the operation input section 11 to switch the recording frame rate, preventing formation of the blurred image. As a result, the state of the main object can be appropriately checked during reproduction of the moving image data.

It is obvious that the invention should not be limited to the above-described embodiments, and various improvements or various modifications or variations in design may be made within the scope without departing from the gist of the invention.

For example, in the first to third embodiments, the imaging controller 6 may control the recording frame rate to be switched between the first normal recording frame rate and the second high recording frame rate depending on a change in state of the object. Specifically, when a predetermined user operation of the operation input section 11 is required to switch the recording frame rate, the apparatus inconveniently moves due to the user operation, leading to formation of a blurred image. Thus, for example, when the change in state of the object is relatively large, the recording frame rate is automatically switched to the second high recording frame rate. This makes the imaging interval between the frame images f to be shorter than the reproduction interval during subsequent reproduction of the moving image, thus enabling apparent slow-motion reproduction. As a result, the state of the main object can be appropriately checked.

While the state detector 6b is separated from the imaging condition adjuster 6c in the first to third embodiments, these may be configured in one section. Specifically, the imaging condition adjuster 6c may further have the function of the state detector 6b, which detects a state of the object.

Furthermore, the configurations of the imaging apparatuses 100, 200 and 300 are illustrated merely by way of example and without limitation. The configuration can be optionally modified or altered as long as it includes an imaging section, an imaging controller, a reproduction controller, an adjuster, and an adjustment controller.

In the above-described embodiments, the functions of a moving image recording means, an adjusting means, a switching means, and an adjustment controlling means are achieved by the recording medium M, the imaging condition adjuster 6c, the first recording-frame-rate setting section 6a, and the imaging controller 6, respectively, which are driven under control of the central controller 14; however this is not limitative. The functions may be achieved by execution of a predetermined program by the CPU of the central controller 14.

Specifically, the program memory 13 stores a program including a moving image recording processing routine, an adjustment processing routine, a switching processing routine, and an adjustment-control processing routine. The CPU of the central controller 14 may function as a moving image recording means, which sequentially records images of an object, the images being sequentially taken by an imaging means, as a series of moving image data, by executing the moving image recording processing routine. The CPU of the central controller 14 may further function as an adjusting means, which adjusts imaging conditions of an object in response to a change in state of the object, wherein the images are taken by the imaging means, during imaging and recording of the series of moving image data by the moving image recording means, by executing the adjustment processing routine. The CPU of the central controller 14 may still further function as a switching means, which switches the frame rate for recording a moving image during imaging and recording of the series of moving image data by the moving image recording means, by executing the switching processing routine. The CPU of the central controller 14 may also function as an adjustment controlling means, which controls the adjustment of imaging conditions by the adjusting means during recording of the data at a second recording frame rate higher than a first recording frame rate when the switching section switches the frame rate for recording the moving image from the first recording frame rate to the second recording frame rate, by executing the adjustment-control processing routine.

Similarly, a reproduction means, a reproduction controlling means, a motion detecting means, a state detecting means, an imaging controlling means, and an object detecting means may be achieved by execution of a predetermined program by the CPU of the central controller 14.

Furthermore, computer-readable media that store programs for executing the above-described various types of processes may include nonvolatile memories such as flash memories and portable recording media such as CD-ROM, in addition to the ROM and the hard disc. In addition, carrier waves may be used as the media for providing program data through a communication line.

In addition, it should be considered that the embodiments disclosed herein are illustrative only and not limitative in all respects. The scope of the invention is indicated by the following claims rather than by the foregoing description. All modifications and variations that fall within the meaning and the scope equivalent to the claims are intended to be included in the scope of the invention.

The entire disclosure of Japanese Patent Application No. 2011-009430 filed on Jan. 20, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An imaging apparatus comprising:
an imaging section that sequentially takes images of an object;
a moving image recording section that sequentially records the images of the object as a series of moving image data;
an adjuster that adjusts an imaging condition for imaging the object in accordance with a change in state of the object taken by the imaging section during imaging and recording of the series of moving image data;
a switching section that switches a recording frame rate for recording a moving image between a plurality of recording frame rates during the imaging and the recording of the series of moving image data, wherein the plurality of recording frame rates include a first recording frame rate and a second recording frame rate that is higher than the first recording frame rate; and
an adjustment controller that controls adjustment of the imaging condition made by the adjuster during the recording of the moving image data at the second recording frame rate, when the switching section switches from the first recording frame rate to the second recording frame rate.

2. The imaging apparatus according to claim 1, wherein
when the switching section switches from the first recording frame rate to the second recording frame rate, the adjustment controller prohibits the adjustment of the imaging condition made by the adjuster and keeps the imaging condition determined before the switching.

3. The imaging apparatus according to claim 1, wherein
when the switching section switches from the first recording frame rate to the second recording frame rate, the adjustment controller controls the adjustment of the imaging condition such that a change of the imaging condition after the switching is more moderate than a change of the imaging condition before the switching.

4. The imaging apparatus according to claim 1, further comprising:
a reproduction section that reproduces the moving image data, which is recorded by the moving image recording section, at a reproduction frame rate identical to a recording frame rate; and
a reproduction controller that controls the reproduction section to reproduce a portion of the moving image data, which is recorded with a recording frame rate temporarily switched to another recording frame rate by the switching section, at a reproduction frame rate different from the recording frame rate.

5. The imaging apparatus according to claim 4, wherein
the reproduction controller controls the reproduction section to continuously reproduce the series of moving image data at a predetermined reproduction frame rate throughout the series of moving image data without switching the reproduction frame rate for both (a) a portion recorded at the first recording frame rate and (b) a portion recorded at the second recording frame rate, so as to reproduce the portion recorded at the second recording frame rate in slow motion.

6. The imaging apparatus according to claim 1, further comprising:
a state detector that detects a state of the object based on a plurality of frame images which constitute the moving image of the object taken by the imaging section, wherein
the state detector detects the state of the object based on the frame images taken at a predetermined interval longer than an interval corresponding to the second recording frame rate while the imaging section is imaging the moving image data at the second recording frame rate.

7. The imaging apparatus according to claim 6, further comprising:
a motion detector that detects magnitude of motion occurring in the imaging apparatus, wherein
when the magnitude of the motion detected by the motion detector is larger than a predetermined value during the recording of the moving image data at the second recording frame rate, the adjustment controller controls the adjustment of the imaging condition such that a recording state of the object in the moving image is gradually changed based on the state of the object detected in each of the frame images taken at the predetermined interval longer than the interval corresponding to the second recording frame rate.

8. The imaging apparatus according to claim 7, wherein
the adjustment controller (a) controls the state detector to detect the state of the object from two frame images taken at the predetermined interval longer than the interval corresponding to the second recording frame rate during the recording of the moving image data at the second recording frame rate, and (b) controls the adjustment of the imaging condition such that the imaging condition is gradually changed from a first imaging condition to a second imaging condition, wherein (i) the first imaging condition is determined according to a state of the object detected in one of the two frame images and (ii) the second imaging condition is determined according to a state of the object detected in the other of the two frame images.

9. The imaging apparatus according to claim 7, wherein
the state detector sequentially detects the state of the object for each of frame images taken at a period corresponding to the first recording frame rate during the recording of the moving image data at the first recording frame rate; and
the adjustment controller controls the adjuster to sequentially adjust the imaging condition for the object based on the state of the object sequentially detected by the state detector.

10. The imaging apparatus according to claim 1, wherein
when the switching section switches from the second recording frame rate to the first recording frame rate, the adjustment controller controls the adjustment of the imaging condition for each of frame images taken at a period corresponding to the first recording frame rate such that a recording state of the object is gradually changed.

11. The imaging apparatus according to claim 1, further comprising:
a motion detector that detects magnitude of motion occurring in the imaging apparatus; and
an imaging controller that controls the imaging section to take the moving image (a) at a period corresponding to the second recording frame rate when the magnitude of the motion detected by the motion detector is smaller than a predetermined value, and (b) at a period corresponding to the first recording frame rate when the magnitude of the motion detected by the motion detector is larger than the predetermined value.

12. The imaging apparatus according to claim 1, wherein
the switching section switches between the first recording frame rate and the second recording frame rate in accordance with an instruction input by a user for switching the recording frame rate.

13. The imaging apparatus according to claim 1, wherein
the switching section switches between the first recording frame rate and the second recording frame rate based on the change in state of the object imaged by the imaging section.

14. The imaging apparatus according to claim 1, wherein
the imaging condition includes at least one of an exposure adjustment condition and a white-balance adjustment condition for imaging the object by the imaging section.

15. The imaging apparatus according to claim 14, further comprising an object detector that detects a particular object in the moving image taken by the imaging section, wherein
the adjuster adjusts at least one of the exposure adjustment condition and the white-balance adjustment condition with reference to the particular object detected by the object detector.

16. An imaging method using an imaging apparatus that includes an imaging section, the method comprising:
sequentially recording images of an object sequentially taken by the imaging section as a series of moving image data;
adjusting an imaging condition for imaging the object in accordance with a change in state of the object taken by the imaging section during imaging and recording of the series of moving image data;
switching a recording frame rate for recording a moving image between a plurality of recording frame rates during the imaging and the recording of the series of moving image data, wherein the plurality of recording frame rates include a first recording frame rate and a second recording frame rate that is higher than the first recording frame rate; and
controlling adjustment of the imaging condition during the recording of the moving image data at the second recording frame rate, when a recording frame rate is switched from the first recording frame rate to the second recording frame rate.
